(19) United States
(12) Patent Application Publication
(10) Pub. No.: US 2006/0139524 A1
(43) Pub. Date: Jun. 29, 2006

(54) Portable multifunction display panel and a liquid crystal display device adopting the same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/261,096

(22) Filed: Oct. 28, 2005

(30) Foreign Application Priority Data
Dec. 28, 2004 (TW) 93140987

(51) Int. Cl. G02F 1/1335

(52) U.S. Cl. 349/114

(57) ABSTRACT

A liquid crystal display device (20) includes a display panel (22) and a backlight module (21) positioned below the display panel. The display panel includes a lower substrate (221), an upper substrate (227) and a liquid crystal layer (224) sandwiched therebetween. One region of a surface of the lower substrate facing the liquid crystal layer is coated with a transmissive layer (2201), and the other region thereof is coated with a reflective layer (2202). In sunlight or in an ambient environment, the sunlight light or the ambient light is reflected by the reflective layer. In a dark or in a dim environment, uniform light beams originating from the backlight module are transmitted through the transmissive layer. The transmissive layer and the reflective layer are in a same plane, helping to ensure that the display panel has a small thickness and a small bulk. Therefore, the liquid crystal display device is readily portable.

### BACKGROUND

1. Field of the Invention

The invention relates generally to display panels and, more particularly, to a portable multifunction display panel and a liquid crystal display device adopting the same.

2. Discussion of Related Art

Liquid crystal display devices have many excellent performance characteristics, such as large-scale information display ability, easy to color, low power consumption, long life, no pollution associated therewith, and so on. Therefore, liquid crystal display devices are used widely. Liquid crystal display devices generally include two types: transmissive liquid crystal display devices and reflective liquid crystal display devices. A typically transmissive liquid crystal display device includes a display panel and a backlight module positioned below the display panel. An energy consumption of the backlight module is relatively large, thereby a total energy consumption of the transmissive liquid crystal display device is relatively large. The reflective liquid crystal display device has a relatively small energy consumption. However, the reflective liquid crystal display device can not work in a dark or in a dim environment.

In order to solve the above-described problems, a semi-transmissive/semi-reflective liquid crystal display device has been developed. Referring to FIG. 4, a conventional semi-transmissive/semi-reflective liquid crystal display device 1 includes a transparent lower substrate 11, an opposite transparent upper substrate 12, and a liquid crystal layer 13, sandwiched between the transparent lower substrate 11 and the transparent upper substrate 12. An upper transparent electrode 14 and an upper alignment film 18 are positioned on an inner surface of the transparent upper substrate 12, in turn. An upper delay sheet 122 and an upper polarizer plate 121 are positioned on an outer surface of the transparent upper substrate 12, in that order. A lower transparent electrode 17, a passivation layer 16, a reflective electrode 15, and a lower alignment film 19 are positioned on an inner surface of the transparent lower substrate 11, in turn. A lower delay sheet 112 and a lower polarizer plate 111 are positioned on an outer surface of the transparent lower substrate 11, in that order. An opening 151 runs through the reflective electrode 15 and the passivation layer 16.

The upper delay sheet 122 and the lower delay sheet 112 are all λ/4 delay sheets. The upper alignment film 18 and the lower alignment film 19 are all homogeneous alignment films. A polarization direction of the upper polarizer plate 121 is perpendicular to a polarization direction of the lower polarizer plate 111. The reflective electrode 15 is made of material having high reflectivity, such as aluminum (Al). The upper transparent electrode 14 and the lower transparent electrode 17 are all made of transparent conductive material, such as indium-tin oxide (ITO) or indium-zinc oxide (IZO). The liquid crystal layer 13 has two regions. One region is a reflective region located between the upper transparent electrode 14 and the reflective electrode 15, and the other region is a transmissive region located between the upper transparent electrode 14 and the transparent electrode 17. A thickness d12 of the transmissive region is about double a thickness d11 of the reflective region.

In a sunlight or in an ambient environment, the sunlight light or the ambient light is reflected by the reflective region, and thereby an image is displayed on the liquid crystal display device 1. This operative state is named a reflection mode, and a corresponding backlight module does not work and, thus, does not consume energy in the reflection mode. Alternatively, in a dark or in a dim environment, the corresponding backlight module emits uniform light beams, and such light beams are transmitted through the transmissive region, thereby facilitating the display of an image on the liquid crystal display device 1. This operative state is called a transmission mode, and the corresponding backlight module operates and consumes energy in the transmission mode.

Therefore, the semi-transmissive/semi-reflective liquid crystal display device 1 can be used either in the sunlight or the ambient environment or in the dark or the dim environment. Furthermore, because the semi-transmissive/semi-reflective liquid crystal display device 1 can adopt the reflection mode or the transmission mode, according to actual environment, energy can thereby be saved by such a unit.

However, the thickness d12 of the transmissive region is about double the thickness d11 of the reflective region, and thus the transmissive region and the reflective region are in different planes. This planar difference results in the semi-transmissive/semi-reflective liquid crystal display device 1 having a relatively large thickness and being relatively bulky. Therefore, the semi-transmissive/semi-reflective liquid crystal display device 1 is not readily portable.

What is needed, therefore, is a portable multifunctional display panel having a small thickness and a small bulk.

What is also needed is a liquid crystal display device adopting the above-mentioned display panel.

### SUMMARY

In one embodiment, a display panel includes a lower substrate, an upper substrate and a liquid crystal layer sandwiched therebetween. A surface of the lower substrate facing the liquid crystal layer has two regions. One region is coated with a transmissive layer, and the other region is coated with a reflective layer. The transmissive layer is made of indium-tin oxide (ITO) or silicon dioxide, and the reflective layer is formed by dispersing nano-particles in an indium-tin oxide (ITO) or silicon dioxide matrix.

In another embodiment, a liquid crystal display device includes the above-described display panel and a backlight module positioned below the display panel. The liquid crystal display device further includes a dual light control (DLC) device electrically connected with the backlight module. The dual light control device has a light brightness sensor to decide if a reflection mode or a transmission mode is to be used.

In a sunlight or in an ambient environment, the liquid crystal display device adopts the reflection mode, and the dual light control device controls/signals the backlight module not to work (i.e., to be of). The sunlight light or the ambient light is reflected by the reflective layer, thereby permitting an image to be displayed on the display panel. In a dark or in a dim environment, the liquid crystal display device adopts the transmission mode, and the dual light control device controls/signals the backlight module to work (i.e., to be on). The backlight module emits uniform light beams, and these light beams are transmitted through the transmissive layer. Accordingly, an image can be displayed on the display panel. The liquid crystal display device adopts the reflection mode or the transmission mode according to actual environment (i.e., level of lighting), and this selective mode feature can save energy

Compared with a conventional liquid crystal display device, the transmissive layer and the reflective layer of the present display panel are in a same plane, and this ensures that the display panel has a small thickness and a small bulk. Therefore, the present liquid crystal display device is readily portable and easily incorporated into various portable electronic devices such as digital cameras, cell phones, and PDA's. Furthermore, the reflective layer has high efficiency of light coupling and light-beam usage due to the nano-particle dispersant, and thus the sunlight or the ambient light is well reflected. This high reflectivity can further save energy by potentially permitting the current display to operate in reflection mode in dimmer conditions than previously possible with the prior transmissive/reflective display panel.

Other advantages and novel features will become more apparent from the following detailed description of preferred embodiments when taken in conjunction with the accompanying drawings.

### BRIEF DESCRIPTION OF THE DRAWINGS

Many aspects of the present display panel and the related liquid crystal display device can be better understood with reference to the following drawings. The components in the drawings are not necessarily to scale, the emphasis instead being placed upon clearly illustrating the principles of the present display panel and the related liquid crystal display device. Moreover, in the drawings, like reference numerals designate corresponding parts throughout the several views.

FIG. 1 is a schematic, cross-sectional view of a liquid crystal display device, in accordance with a preferred embodiment of the present device;

FIG. 2 is an enlarged view of part of FIG. 1, showing paths of light beams transmitted therein;

FIG. 3 is an isometric view of an electronic device adopting the liquid crystal display device of FIG 1; and

FIG. 4 is a schematic, cross-sectional view of a conventional liquid crystal display device.

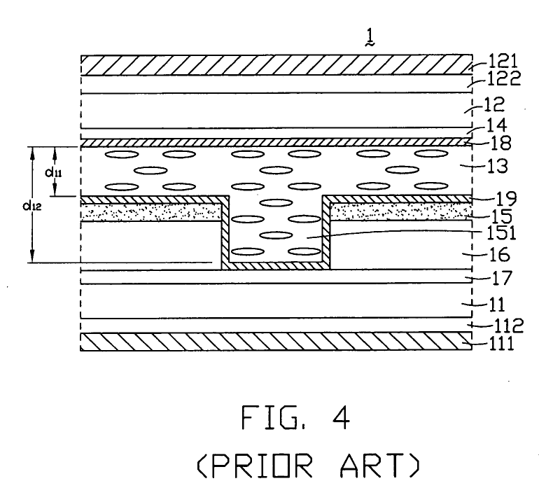

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe embodiments of the present display panel and the liquid crystal display device employing the same, in detail.

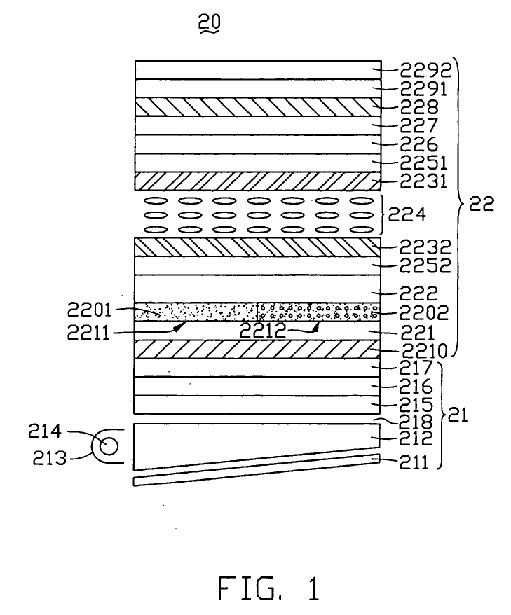

Referring to FIG. 1, a liquid crystal display device 20, in accordance with a preferred embodiment of the present device, includes a display panel 22 and a backlight module 21 positioned below the display panel 22. The backlight module 21 includes a light guide plate 212, a light source 214, a cover 213, a reflective plate 211, a diffusion plate 215, a bright-enhancement-film (BEF) 216 and a double-bright-enhancement-film (DBEF) 217. The light source 214 is covered by the cover 213 and is positioned beside the light guide plate 212. The reflective plate 211 is positioned below the light guide plate 212, and the diffusion plate 215, the bright-enhancement-film 216 and the double-bright-enhancement-film 217 are positioned upon the light guide plate 212, in turn. Furthermore, an air gap 218 is defined between the diffusion plate 215 and the light guide plate 212. The air gap 218 should be as small as possible, i.e. less than 0.1 millimeter.

The light source 214 can be, e.g., a cold cathode fluorescent lamp (CCFL), a light emitting diode (LED), a light emitting diode bundle, a field emission device, or another compact light source. The light guide plate 212 is wedge-shaped, with one end thereof being much thicker than the opposing end. The thicker end thereof is positioned near the light source 214. The light guide plate 212 is used to transmit incident light beams, emitted from the light source 214, from the thicker end to the other opposing end thereof and then eventually out of light guide plate 212 toward the diffusion plate 215, via total reflection. Therefore, the linear light source 214, such as a cold cathode fluorescent lamp, or the point light source 214, such as a light emitting diode, is converted into an area light source having a high uniformity and brightness.

The reflective plate 211 has aluminum or silver coated thereon (or, alternatively, is made entirely of a suitably reflective material) and is used to reflect some of the incident light beams that are emitted from a bottom surface of the light guide plate 212 and back into the light guide plate 212. This reflection enhances the utilization ratio of the incident light beams from light source 214. The diffusion plate 215 and the bright-enhancement-film 216 are used to further improve the uniformity of the light emitted from (i.e., transmitted out of) the light guide plate 212. The double-bright-enhancement-film 217 is used to enhance the utilization ratio of the incident light beams (i.e., the degree to which the strength of the light beams emitted from light source 214 is able to be maintained through the device).

The display panel 22 includes a transparent lower substrate 221, a transparent upper substrate 227, and a liquid crystal layer 224. The transparent upper substrate 227 is opposite to the transparent lower substrate 221. The liquid crystal layer 224 is sandwiched between the transparent lower substrate 221 and the transparent upper substrate 227. An inner surface of the lower substrate 221 facing the liquid crystal layer 224 has two regions, a first inner surface region 2211 and a second inner surface region 2212. The first inner surface region 2211, in the embodiment shown is coated with a transmissive layer 2201, and the second inner surface region 2211, as shown is coated with a reflective layer 2202. Advantageously, layers 2201, 2202 are substantially or, even more preferably, essentially coplanar, thereby adding to the compactness of the device 20, by having two functionally different layers occupy the same level in the device. Preferably, the two side-by-side layers 2201, 2202 will have nearly the same thickness to avoid the need to include spacers to accommodate any significant difference in thickness therebetween. It is also to be understood that the regions occupied by layers 2201, 2202 could be reversed and/or that, in certain cases (e.g., based upon lighting conditions), it may prove advantageous for one of the layers to occupy a larger area/region than the other.

A thickness of the transmissive layer 2201 and/or the reflective layer 2202 is in the approximate range from 100 to 500 nanometers, with each advantageously having a similar thickness as the other and thus each having an approximate thickness in the cited range. The transmissive layer 2201 is made of indium-tin oxide (ITO) or silicon dioxide, and more than 90 percent of the emitted light beams from the backlight module 21 can be transmitted through the transmissive layer 2201. The reflective layer 2202 is formed by dispersing nano-particles in an indium-tin oxide (ITO) and/or silicon dioxide matrix. The nano-particles are made of a reflective material, such as aluminum particles and/or silver particles, and a size of each such nano-particle is about in the range from 2 to 100 nanometers. In the preferred embodiment, the size of each nano-particle is in the approximate range of from 5 to 20 nanometers. The reflective layer 2202 has a high efficiency of light coupling and light-beam usage due to the nano-particle dispersant. Accordingly, the sunlight or the ambient light is well reflected by such a reflective layer 2202.

The display panel 22 further includes a lower polarizer plate 2210 and a thin film transistor (TFT) 222. The lower polarizer plate 2210 is positioned on an outer surface of the lower substrate 221. The thin film transistor (TFT) 222 is located on the transmissive layer 2201 and on the reflective layer 2202, contacting both layers 2201, 2202 in the illustrated embodiment. Furthermore, the display panel 22 inludes a lower alignment film 2232 and a lower transparent electrode 2252, each positioned below the liquid crystal layer 224, in that order.

Further, an upper alignment film 2231 and an upper transparent electrode 2251 are provided, in turn, upon the liquid crystal layer 224. Still furthermore, the display panel 22 includes a color filter 226, a upper polarizer plate 228, an anti-glare layer 2291, and an anti-reflection layer 2292. The color filter 226 is arranged on an inner surface of the upper substrate 227. The upper polarizer plate 228, the anti-glare layer 2291, and the anti-reflection layer 2292 oriented on an outer surface of the upper substrate 227 in turn.

A polarization direction of the upper polarizer plate 228 is perpendicular to a polarization direction of the lower polarizer plate 2210. The upper alignment film 2231 and the lower alignment film 2232 are all homogeneous alignment films and are advantageously made of polyimide. Polyimide is anti-high temperature (i.e., thermally resistant), anti-wear and tear (i.e., mechanically tough/durable), and anti-erode (i.e., corrosion resistant). The upper transparent electrode 2251 and the lower transparent electrode 2252 are usefully made of indium-tin oxide (ITO). The transparent electrodes 2251, 2252 are, respectively, formed on the upper polarizer plate 228 and the lower polarizer plate 2210, each by means of direct current sputtering or radio frequency sputtering. The indium-tin oxide has a high reflectivity, not only in the range of visible light but also in the range of infrared light. In the preferred embodiment, the thin film transistor 222 is an active matrix thin film transistor and is used to actively control a luminous flux of each picture displayed via the liquid crystal layer 224.

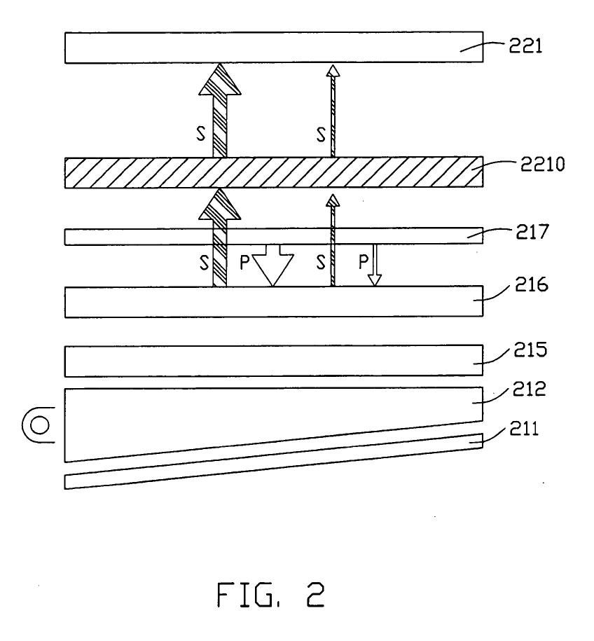

Referring to FIG. 2, a light beam emitted from the light source 214 includes both p-polarization light and s-polarization light, which is perpendicular to the p-polarization light. A polarization direction of the p-polarization light is perpendicular to the polarization direction of the lower polarizer plate 2210, and a polarization direction of the s-polarization light is parallel to the polarization direction of the lower polarizer plate 2210. The light beam is transmitted through the light guide plate 212, the diffusion plate 215, the bright-enhancement-film 216 and the double-bright-enhancement-film 217 in order to reach the lower polarizer plate 2210. Then, the s-polarization light is transmitted through the lower polarizer plate 2210, but the p-polarization light can not be transmitted therethrough. The p-polarization light is converged by the double-bright-enhancement-film 217, is reflected into the backlight module 21, and is converted into p-polarization light and s-polarization with a relatively small intensity. Thus, the light beam can, at least theoretically, be used completely after several such processes.

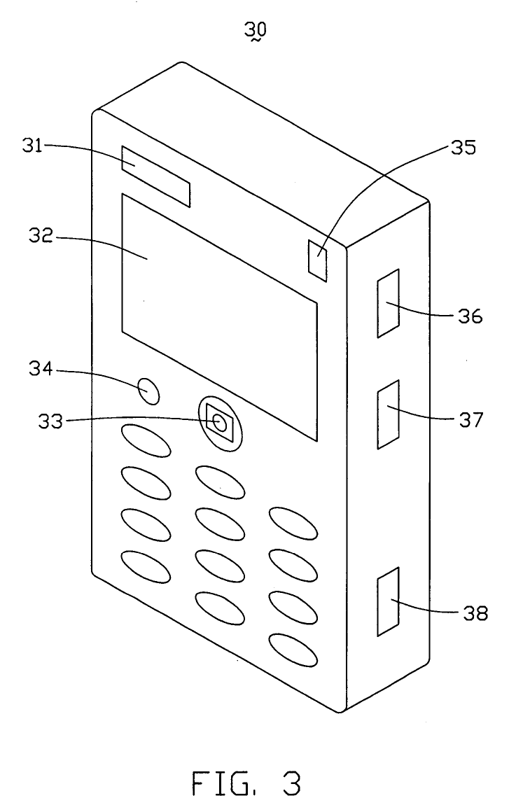

Referring to FIG. 3, an electronic device 30 adopting the liquid crystal display (LCD) device 20 is shown. The electronic device 30 illustrated has a variety of functions, such as TV tuner 31, digital still camera (DSC) 33, MP3 player 34, radio 35, DVD 36, hard disk drive for data/video storage 37 and so on. The electronic device 30 has multiple functions, and thus energy saving is desired or even necessary to make its use feasible. Therefore, a dual light control (DLC) device 38, incorporating a light brightness sensor and a related logic circuit/processor (neither specifically shown) therein, is electrically connected with the backlight module 21 in the electronic device 30. The dual light control (DLC) device 38 is used to decide whether to adopt a reflection mode or a transmission mode based upon a sensed degree of brightness of the light registered by the sensor associated with the DLC device 38. The DLC device 38 advantageously has adjustable sensitivity and can be controlled according to a given users' comfort (i.e., based on the brightness level that the user feels is needed to adequately view the display). It is to be understood that, while electronic device 30 serves as an illustrative example, any electronic device having a liquid crystal display could potentially employ the LCD device 20 to take advantage of some or all the features of the present LCD device 20.

In the sunlight or in the ambient environment, the dual light control device 38 controls the backlight module 21 not to work (i.e., be off) and the liquid crystal display device 20 adopts the reflection mode. The sunlight light or the ambient light is reflected by the reflective layer 2202, thereby providing the light needed for an image to be displayed on a liquid crystal display screen 32. In the dark or in the dim environment, the dual light control device 38 controls the backlight module 21 to work (i.e., be on and thus produce light), and the liquid crystal display device 20 adopts the transmission mode. The backlight module 21 emits essentially uniform light beams, and these light beams are transmitted through the transmissive layer 2201, and thereby an image is able to be displayed on the liquid crystal display screen 32. The liquid crystal display device 20 adopts the reflection mode or the transmission mode according to the actual level of available light, and this adaptability can save energy.

Compared with a conventional liquid crystal display device, the transmissive layer 2201 and the reflective layer 2202 of the present display panel 22 are in a same plane, and that such layers 2201, 2202 are coplanar helps the display panel 22 to have a small thickness and a small bulk. Therefore, the present liquid crystal display device 20 is quite portable and able to be suitably incorporated into portable electronic devices that are intended to be carried in, e.g., a pocket, purse, book bag, or briefcase. Furthermore, the reflective layer 2202 has a high efficiency of light coupling and light-beam usage due to the nano-particle reflective material therein, and thus the sunlight or the ambient light can be effectively reflected thereby. The effectiveness of such reflection can further save energy by allowing operation in the reflection mode even under somewhat dim lighting. Therefore, the present liquid crystal display device 20 can be widely used in such devices as mobile telephones, personal digital assistants (PDA), personal media players (PMP), portable DVD, notebooks, and display devices used in autos.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A display panel comprising: a lower substrate having an inner surface, the inner surface having a first inner surface region and a second inner surface region;
an upper substrate opposite to the lower substrate;
a liquid crystal layer sandwiched between the lower substrate and the upper substrate;
a transmissive layer formed on the first inner surface region of the lower substrate;
a reflective layer formed on the second inner surface region of the lower substrate, the reflective layer being substantially coplanar with the transmissive layer.

2. The display panel as claimed in claim 1, wherein the transmissive layer is comprised of at least one of indium-tin oxide and silicon dioxide.

3. The display panel as claimed in claim 1, wherein the reflective layer is comprised of a matrix with nano-particles dispersed therein, the nano-particles promoting reflection of light.

4. The display panel as claimed in claim 3, wherein a size of each nano-particle is in the approximate range of from 2 to 100 nanometers.

5. The display panel as claimed in claim 4, wherein the size of each nano-particle is about in the range of from 5 to 20 nanometers.

6. The display panel as claimed in claim 3, wherein the matrix is comprised of at least one of Indium indium-tin oxide and silicon dioxide, the nano-particle each being comprised of at least one of aluminum and silver.

7. The display panel as claimed in claim 1, wherein a thickness of each of the transmissive layer and the reflective layer is about in the range of from 100 to 500 nanometers.

8. The display panel as claimed in claim 1, wherein a lower polarizer plate is positioned on an outer surface of the lower substrate.

9. The display panel as claimed in claim 1, wherein a thin film transistor is positioned on the transmissive layer and on the reflective layer.

10. The display panel as claimed in claim 1, wherein a lower alignment film and a lower transparent electrode are positioned, in order, below the liquid crystal layer, and an upper alignment film and an upper transparent electrode are arranged upon the liquid crystal layer, in turn.

11. The display panel as claimed in claim 10, wherein the upper alignment film and the lower alignment film are homogeneous alignment films and are comprised of polyimide.

12. The display panel as claimed in claim 10, wherein the upper transparent electrode and the lower transparent electrode are comprised of indium-tin oxide.

13. The display panel as claimed in claim 1, wherein a color filter is positioned on an inner surface of the upper substrate, an upper polarizer plate, an anti-glare layer and an anti-reflection layer being positioned, in order, on an outer surface of the upper substrate.

14. A liquid crystal display device comprising:
a display panel comprising:
a lower substrate having an inner surface, the inner surface thereof having a transmissive layer and a reflective layer both formed directly thereon;
an upper substrate opposite to the lower substrate; and
a liquid crystal layer sandwiched between the lower substrate and the upper substrate; and
a backlight module positioned below the display panel.

15. The liquid crystal display device as claimed in claim 14, further comprising a dual light control device electrically connected with the backlight module, the dual light control device being configured for selectively turning on and turning off the backlight module based upon a degree of brightness of light sensed by the dual light control device.

16. The liquid crystal display device as claimed in claim 14, wherein the backlight module comprises a light guide plate and a light source positioned adjacent the light guide plate.

17. The liquid crystal display device as claimed in claim 16, wherein a reflective plate is situated below the light guide plate, and a diffusion plate, a bright-enhancement-film and a double-bright-enhancement-film are positioned, in order, upon the light guide plate.

18. The liquid crystal display device as claimed in claim 14, wherein the transmissive layer is comprised of at least one of indium-tin oxide and silicon dioxide, and the reflective layer has a matrix comprised of at least one of indium-tin oxide and silicon dioxide, the matrix further having nano-particles dispersed therein.

19. The liquid crystal display device as claimed in claim 18, wherein a size of each nano-particle is in the approximate range of from 2 to 100 nanometers.

20. The liquid crystal display device as claimed in claim 14, wherein a thickness of each of the transmissive layer and the reflective layer is about in the range of from 100 to 500 nanometers.
